(19) United States
(12) Patent Application Publication
(10) Pub. No.: US 2018/0041532 A1
(43) Pub. Date: Feb. 8, 2018

(54) System for Handling Communicated Threats

(71) Applicant: Jessica Anne Johnson, Felton, CA (US)

(72) Inventor: Jessica Anne Johnson, Felton, CA (US)

(73) Assignee: Roblox Corporation, San Mateo, CA (US)

(21) Appl. No.: 15/227,177

(22) Filed: Aug. 3, 2016

(51) Int. Cl. H04L 29/06

(52) U.S. Cl. CPC H04L 63/1433

(57) ABSTRACT

A system has a threat-resolution server connected to a wide-area network and having a processor executing first threat-processing software from a non-transitory medium, and a computerized appliance connected to the WAN at a business enterprise executing second threat-processing software. The second threat-processing software enables a standardized summarization of an identified threat, gathering of available data useful for identifying a source of the threat, and transmission of a threat report to the threat-resolution server, where the first threat-processing software enables determination of a threat source from the data transmitted, suggests resolution steps back to the computerized appliance, and notified law-enforcement agencies, suicide prevention services, and other services as determined to be needed by nature of the threat.

### BACKGROUND OF THE INVENTION

### 1. Field of the Invention

The present invention is in the field of electronic security relative to data and telephony networks, including security incident detection handling and reporting, and pertains particularly to methods and apparatus for gathering optimum information relative to a threat to security or other emergency issue relative to a business, including personnel associated with the business, such as employees, operators, and customers.

### 2. Discussion of the State of the Art

In the art of electronic security, there are a substantial number of varying types of security systems, including video surveillance and alarm systems, theft prevention systems, and specific levels of cyber-protection relative to electronic networks owned or leased by enterprises for business use.

Many enterprises have many repeat clients or customers, some of whom may potentially be threatening or otherwise may be involved in a situation that may serve as an emergency of sorts, depending upon the issue at the time. Enterprises or persons associated with an enterprise may occasionally receive threats or warnings of an impending hostile action. Some of these interactions may lead to violence, such as a bombing or shooting such as incidents that have been well documented in the art.

Administrators working at such enterprises may be trained to interface with local authorities including security teams that may be employed by the enterprise. Such administrators may be charged with identifying a possible threat or emergency issue, determining the level of appropriate concern relative to the specific threat or emergency issue, and then communicating the information to local enforcement agencies, first responders, or other designated service authorities.

One challenge to an ad-hoc administrative approach to dealing with threats is that whosoever receives a threat at an enterprise may not initially perceive or understand the nature or potential likelihood of the threat being carried out, largely due to lack of training. Also, the persons own background may affect how a threat is perceived. As a result, a received threat may not get the appropriate attention and fast response that may be warranted.

Another challenge for an enterprise is that with the advent of the Internet and Internet-based communications networks, threats may be received over multiple different communications channels or networks, and with certain enterprises, such as gaming enterprises, threats may be issued through social interaction or gaming interaction where test messaging or chat is active. Additionally, the source of a threat may be local or from another region, or country (international client base). Therefore, a wide variety of information must be accessed quickly, and must be presented convincingly to a third party with jurisdiction in the region of the threat.

Much effort may be expended gathering information required to submit a credible report to a third party regarding a perceived threat. Many enterprises rely on some written policy or procedure for dealing with potential threats, including initiating emergency procedures and alerting local authorities. However, in many areas local authorities are not equipped to quickly discern, for example, a physical residence address for a threat source expressed as an Internet Protocol (IP) address. Newer communications models may also pose set-backs for authorities attempting to link a threat to a perpetrator (threat against others or enterprise) or person in need (mental breakdown, suicide, etc.).

Therefore, what is clearly needed is threat management and reporting system that reduces or eliminates the complexity associated with threat reporting and management.

### BRIEF SUMMARY OF THE INVENTION

In one embodiment of the invention a system is provided, comprising a threat-resolution server connected to a wide-area network and having a processor executing first threat-processing software from a non-transitory medium, and a computerized appliance connected to the wide area network (WAN) at a business enterprise executing second threat-processing software. The second threat-processing software enables a standardized summarization of an identified threat, gathering of available data useful for identifying a source of the threat, and transmission of a threat report to the threat-resolution server, where the first threat-processing software enables determination of a threat source from the data transmitted, suggests resolution steps back to the computerized appliance, and notified law-enforcement agencies, suicide prevention services, and other services as determined to be needed by nature of the threat.

In one embodiment the computerized appliance is connected to a local-area network (LAN) hosted by the business enterprise, the LAN including communication channels used by the business enterprise, and the second threat-processing software enables analysis of interactions over the communication channels to determine and instantiate threat reports. Also in one embodiment interactions over voice channels are treated by voice-to-text conversion to produce text versions of voice interactions, and wherein text of interactions over all channels is compared to stored word and phrases to determine threat content. Also in one embodiment determination of threat content by the second software is displayed for analysis on a display screen of the computerized appliance to enable administrative personnel to make a manual analysis.

In one embodiment of the system the second software enables prioritizing of threat level, using stored definitions and rule sets. Also in one embodiment the first threat-processing software enables statistical analysis and reporting of threats. And in one embodiment statistical analysis and reporting is by enterprise and by threat type.

In another aspect of the invention a method is provided, comprising identifying a threat by execution of threat-processing software executing on a computerized appliance at a business enterprise, gathering available data useful in identifying a source for the threat, preparing a threat report and transmitting the report to a threat-resolution server connected to a wide-area network, the server executing a first threat-processing software, determining a source of the threat from the data transmitted from the computerized appliance, transmitting suggestions for resolution back to the computerized appliance from the WAN-connected server, and notifying law-enforcement agencies, suicide prevention services, and other services as determined to be needed by nature of the threat.

In one embodiment of the method the computerized appliance is connected to a local-area network (LAN) hosted by the business enterprise, the LAN including communication channels used by the business enterprise, and the second threat-processing software analyzes interactions over the communication channels to determine and instantiate threat reports. Also in one embodiment interactions over voice channels are treated by voice-to-text conversion to produce text versions of voice interactions, and wherein text of interactions over all channels is compared to stored word and phrases to determine threat content. Also in one embodiment determination of threat content by the second software is displayed for analysis on a display screen of the computerized appliance to enable administrative personnel to make a manual analysis. Also in one embodiment the second software enables prioritizing of threat level, using stored definitions and rule sets.

In one embodiment of the method the first threat-processing software enables statistical analysis and reporting of threats. Also in one embodiment statistical analysis and reporting is by enterprise and by threat type.

### BRIEF DESCRIPTION OF THE SEVERAL VIEWS OF THE DRAWINGS

FIG. 1 is an architectural overview of a communications network supporting cooperative threat management and reporting according to an embodiment of the present invention.

FIG. 2 is a block diagram depicting functional modules of a client software application used to gather information and report a threat.

FIG. 3 is a block diagram depicting functional modules of a parent software application used to process threat data and alert appropriate authorities.

FIG. 4 is a process flow chart depicting steps for two-party management of a threat received by one of the parties according to an embodiment of the present invention.

### DETAILED DESCRIPTION OF THE INVENTION

In various embodiments described in enabling detail below, the inventor provides a system for managing a threat received by one of two or more collaborating parties. The present invention is described in enabling detail using the following examples, which may describe more than one relevant embodiment falling within the scope of the present invention.

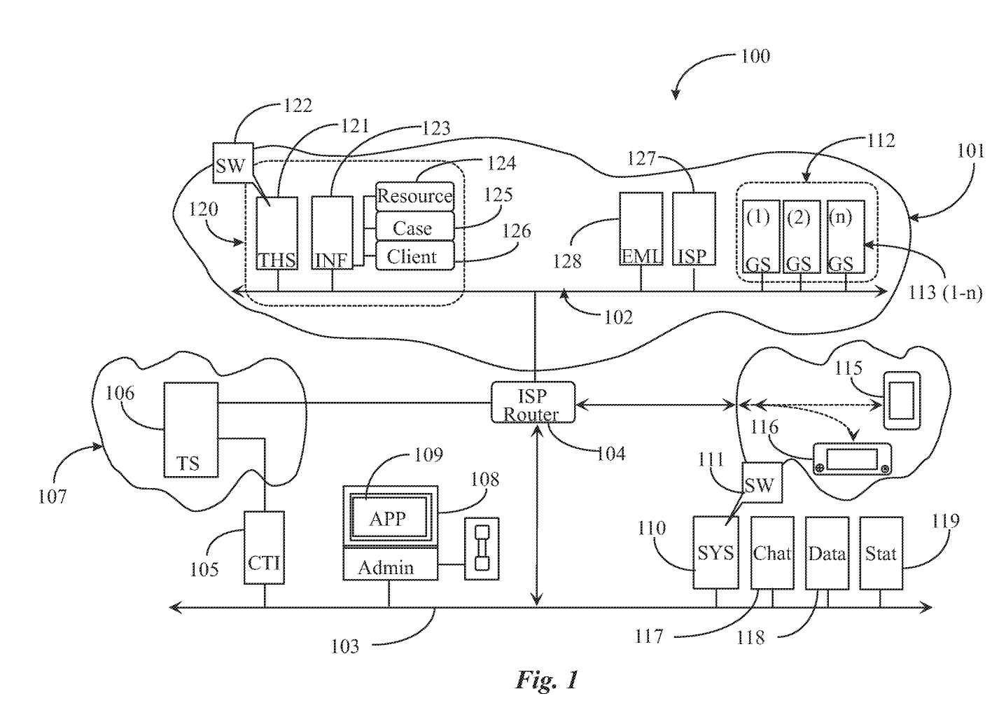

FIG. 1 is an architectural overview of a communications network 100 supporting cooperative threat management and reporting according to an embodiment of the present invention. Communications network 100 includes a wide area network (WAN) 101. WAN 101 may be the well-known Internet network and may be referred to hereinafter in this specification as Internet 101. Internet 101 may be further characterized by a network backbone 102. Backbone 102 represents all of the lines, equipment, and access points making up the Internet network as a whole including any connected sub-networks.

In this exemplary architecture, a sub-network defined by a network backbone 103 is depicted having network access to Internet backbone 102 via a router, in this case, an Internet service provider (ISP) owned router 104 having connection to backbone 102 and a connection to backbone 103. Network 103 may be a local area network (LAN) such as an Ethernet network. Network 103 may be a LAN network used by a business entity. Therefore, network backbone 103 may support all of the necessary equipment and nodes required to operate as a business and to have access to Internet network 102. As such, the business may be any type of business that deals with customers. LAN 103 may also belong to a non-profit or educational group or entity such as a school, government agency, recreational business, and so on.

In one example LAN 103 belongs to a network-based gaming service provider. In this embodiment, the gaming service provider functions to provide access to Internet-based gaming to subscribing local, national, and international customers. The type description or business model should not be construed as a limitation of the present invention, as any business who may have a likelihood of getting threats could subscribe to the service of the invention. However, some business models may have a statistically higher probability of receiving a threat over other business models. The inventor chooses a gaming provider for this example, to allow discussion of multiple geographically local, national, or international sources of received threats to the business or individuals associated therewith.

LAN 103 may have a computer telephony integrated (CTI) telephony system 105 that may be connected to a local telephone switch 106 supported in a telephone network 107. Telephone switch 106 may be an automated call distributor (ACD) switch or an intelligent call routing switch without departing from the scope of the present invention. Telephone network 107 may be a public switched telephone network (PSTN), or a private telephone network without departing from the spirit and scope of the present invention. CTI node 105 is accessible to any authorized administrators operating on LAN 103, CTI software (not illustrated) may be adapted to retain in one location all parameters of telephone communications between a person or system operating on LAN 103, and calls incoming from switch 106.

In this embodiment, an administrative worker or a trained knowledge worker using a laptop computer 108 has connection to LAN 103 and may be running a client SW application 109 available to the administrator through a LAN-connected system server 110 running software 111. SW 111 may not be specifically required locally in order to practice the invention. In one embodiment, SW 111 may be hosted on LAN 103, possibly at the network portal of the service provider. However, in this implementation local SW 111 and functions thereof are provided to expedite threat evaluation and resolution functions.

System server 110 may be a front-end or back-end control server that may serve applications for administrators, such as application 109 on admin laptop 108. In one embodiment an administrator is logged onto server 110 through application 109. Such a user may be a trained worker that is monitoring several disparate communications systems for any type of threat that might come in over any of multiple communications channels.

The service provider operating LAN 103 may use a third-party hosting service to store games for play by subscribers. In this implementation, a game server group 112 is accessible to subscribers and includes game servers (GS) 113 (1-n) adapted to serve games to accessing subscribers. In actual practice, game servers 113 (1-n) may be distributed geographically over the network for servicing clients that are local to the area of the point of distribution.

Communications network 100 in this example includes at least one wireless carrier network 114 providing wireless access to Internet 102 and to authorized nodes connected to LAN 103 via ISP/Router 104. Game subscribers may be represented by mobile wireless devices 115 (smart phone) and 116 (mobile gaming unit). Subscribers may also use gaming boxes, desktop computers, or laptop computers to access and play games wirelessly if applicable or using a wired connection such as cable, or other Internet access service line.

While network-based gaming is not required or necessary for a business to practice the present invention, it is noted herein and will be appreciated by the skilled artisan that potential threats may be communicated through a gaming platform using messaging, captions, or through an associated or integrated chat platform. Moreover, the geographic source of such a threat may be anywhere subscribers may access and play games through the service provider. Other business models may also have repeated contact with local, national, and international customers any of whom could potentially pose a threat on the business or on persons associated with the business.

LAN 103 supports a variety of other service nodes including a chat server 117, a data server 118, and a statistics server 119. In the case of a gaming business, chat server 117 may host chat sessions between registered players. Data server 118 is adapted to store and serve data about players, including contact information, gaming history, payment and account history, etc. Stat server 119 also in one embodiment may be adapted to provide statistical information relative to a specific threat or relative to any particular communications channel over which the threat may arrive.

A threat may come into a business by telephone, email, instant message, chat transcript, board post, or through an interactive online activity such as gaming, or by any other channel or protocol known in the art. Internet backbone 102 in this example supports a threat management service provider 120. Service provider 120 may be a government agency, a non-profit organization, or a for profit business providing network-based threat management service for business clients like the business operating LAN 103. Service provider 120 may include a threat handling server (THS) 121 hosting a software (SW) application 122. Threat handling server 121 may be a portal server that business clients may subscribe to through a Website (not illustrated) for network assistance in expeditious handling of threats. SW 122 may be adapted to process incoming threat submissions posted or otherwise submitted to the service provider by business clients logged into server 121. Service provider 120 may include an information (INF) server 123 that may be adapted to serve information to threat handling server 121 in the course of processing a threat submission.

Information server 123 may manage and serve data held in connected data repositories 124, 125, and 126. Repository 124 may hold resource information such as emergency contact information of service departments and agencies (police, medical, suicide intervention, etc.) that may exist across a wide geographic area not limited to spanning internationally. Repository 125 may hold case information for each pending (unresolved, open) threat submission and associated data relative to the business client and case information that has been resolved (closed) and archived (activity history). Repository 126 may hold client information such as business contacts, business account data including security data, payment history, subscription status, etc.

In general use of the service of the present invention, a system administrator such as one operating laptop 108 may detect, receive directly, or otherwise be alerted to an existing threat. In one implementation SW application 109 may detect a threat through monitoring of incoming channels over which a threat may arrive. Such a SW implement may be programmed to read and disseminate text and match the text to a data library of common threat words, phrases, etc.

In a variation of the implementation described immediately above, the monitoring component may also recognize voice and transcribe it to text for the matching process during monitoring. Monitoring may be periodic or consistent such as throughout a work period. The monitoring targets may be any incoming communication channel to the business. In another implementation, threats may be discovered manually by any persons associated with the client business including but not limiting to trained individuals. Once a threat is detected, SW 109 may aid in gathering any data from the data system used by the business that might be relevant to any data discovered in or associated with the detected threat.

SW 109 may aid in generation of a threat report for submission or upload through the service portal accessible to the administrator through app 109 or through any browser or network (Internet) navigation application. A formal threat submission form may be populated with as much relevant data that the information gathering component has gathered relative to the instant threat in process. As this process operates locally, the administrator may make a decision to alert local authorities or services either as a unilateral decision or as the result of a prompt from application 109. In one embodiment the submission form may be largely or completely automatically populated.

In one implementation there may be a component to SW 109 that grades and marks a threat level for the processed threat according to relevant information gathered and a set of rules governing threat categories and potential credibility of the threats classed into those categories. Some threats may be prioritized over others if there are more than one threat being processed. A notification alert may be displayed to the administrator to recommend alerting specific local authorities or services and may also provide the most current contact information relative to those recommended services or agencies.

Once a threat submission is received at server 121, it is disseminated with the aid of SW 122. SW 108 may perform more information gathering or searching of data stores to append to the data submitted in the form originally with more relevant data, increasing the amount of information that will ultimately be reported to an authority or agency. This may include cooperation with an Internet service provider (ISP), or an email service provider 128 to retrieve information based on data from the threat shared with those entities in the process of identifying the source of the threat being processed. Cooperation shall not be limited to the mentioned host services but may extend to any other service provider that a person or group identified as having authored or sent in the threat may belong to. Typically, business-to-business relationships may be established between the service of the invention and any service host that may have data about the threat originator such as subscription information, and so on.

Service provider 120 may, at any time, make a determination to contact authorities via email, message, voice call, or through other communications methods should they be available to the service host and at the location of the particular authorities. Service provider 120 may furthermore record and store all of the information ultimately associated with a processed threat and may report information back to business client subscribers.

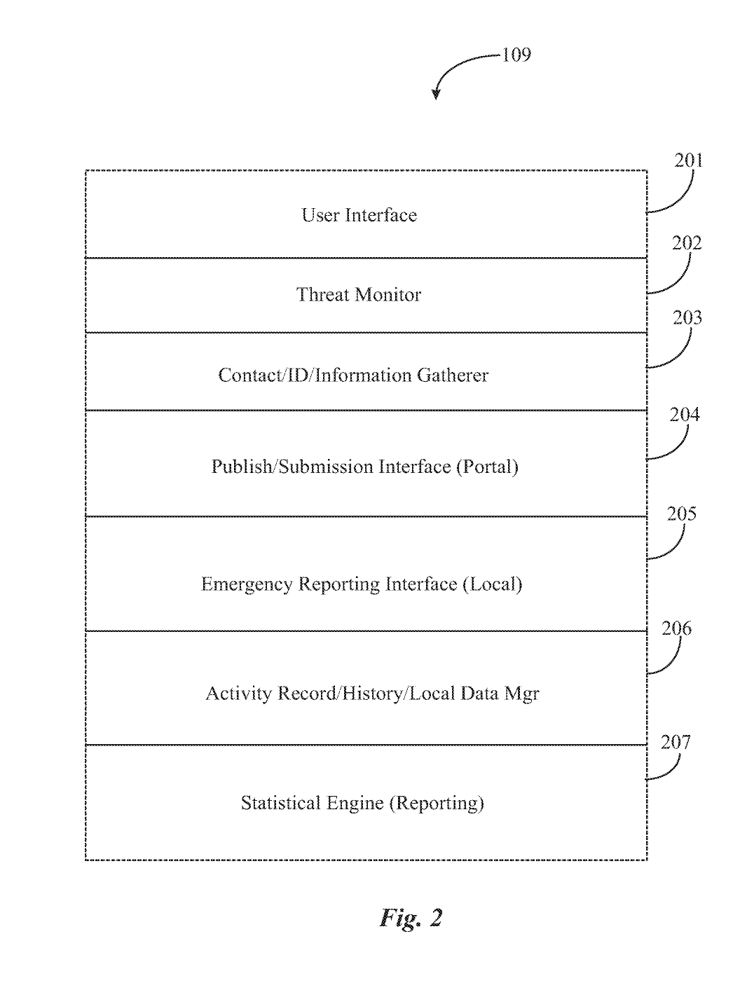

FIG. 2 is a block diagram depicting modules of client software application 109 used to gather information and submit a threat report. Application 109 may include a user interface 201, which may be a browser-based module that that may be executed by the user to visit a portal site hosted by the threat handling service provider. User interface 201 may be customized for specific users and may be available to selected operators or administrators charged with managing threats. Such an interface may display data and other information useful to the administrator and may include an option to log-on to the threat handling server.

In one implementation, application 109 includes a threat monitor 202. Threat monitor 202 may be a background process that samples or monitors incoming communications channels for threats. In this optional embodiment the monitor relies on a set of rules and a linguistic library that may be stored locally at the business, or in one variation, at the service provider location but available through the network. Such a module may have text recognition and voice-to-text translation and recognition capabilities. A threat monitor may be integrated to any of the communications channels and may be programmed to recognize multiple languages, etc. Should a threat monitor detect a threat, it may generate an alert or notification that may pop up to an administrator working in the application.

Application 109 may include an information gathering agent 203 adapted to self-execute and gather information from business-hosted data stores that might be relevant to information associated with the detected threat such as chat handle, email address, game position, game identity, messaging ID, caller ID, name, account number, or any other data entity that might be retrieved locally to help identify and resolve the threat issue.

In this regard the gathering agent may be spawned and may be integrated such as via computer telephony integration (CTI) to a telephone system and may access pertinent telephony data that may be included in a voice data stream, including any routing information available such as the pathway of the call through the network. Likewise, gathering agent 203 may be integrated to any other communications channel for the purpose of gathering any information associated with a communication that has been flagged as a threat. Gathering agent 203 is programmed to retrieve information that might help identify an individual or group issuing a threat and information that may help point to a source location from whence the threat was issued.

Application 109 may include a publish/submit interface 204. Interface 204 may be accessible to a user that is currently logged in to the threat handling server. Publish/submit interface 204 may provide an electronic form having dedicated form fields to populate with specific information relative to the threat event. In one aspect of the process, gathering agent 203 automatically populates the threat submission form with the relevant information it has. In one implementation the administrator may add information manually including witness comments or other data that was not available to the information gathering agent.

Application 109 may also include an emergency reporting interface 205 adapted to provide the administrator with simple communications access to all local agencies for reporting purposes. In one embodiment, application 109 may urge or notify the administrator when a threat needs to be reported locally and may suggest which services to report the incident to, alleviating a requirement of manual data search of emergency contact information. In one implementation an administrator working in application 109 may send the populated threat submission form to the local agencies when reporting the threat incident. The form may be sent as a file type that the local agencies are familiar with such as PDF etc.

Application 109 may include a local data manager 206 adapted to record activity of the administrator working in the application and managing threat processing history. Data manager 206 may also be executed to retrieve data manually from local data stores and to effect manual data updates to those data stores. In one implementation, data manager 206 may cooperate with information gatherer 203 to provide entry links to pertinent data stored in one or more data repositories where that data is about the threat issuer such as account data, historical activity, subscription data, password data, contact data, and so on. Of course, it may be that a threat being processed came from the outside of the business domain and from an individual not known to the business. In this case, the information gatherer may only populate the form with immediate data surrounding the threat incident.

Application 207 may include a statistical engine 207 adapted to report statistical information about threat processing history at the local business. An administrator working in application 109 may call up data revealing numbers associated with local threat processing over a period of time. Such data may reveal for example the communications channel where most of the threats over a period of time were detected or received. The stat engine may generate periodic reports to the administrator and present them in an interactive manner. Threats that have been processed over time may be categorized and associated such that the administrator may determine, for example, which types of threats have been more prevalent over other types or the percentage of total threats that have been resolved successfully and which threats are open or pending resolution. Administrators may use such data to make security improvements in the local communications network and to revisit and modify security policy.

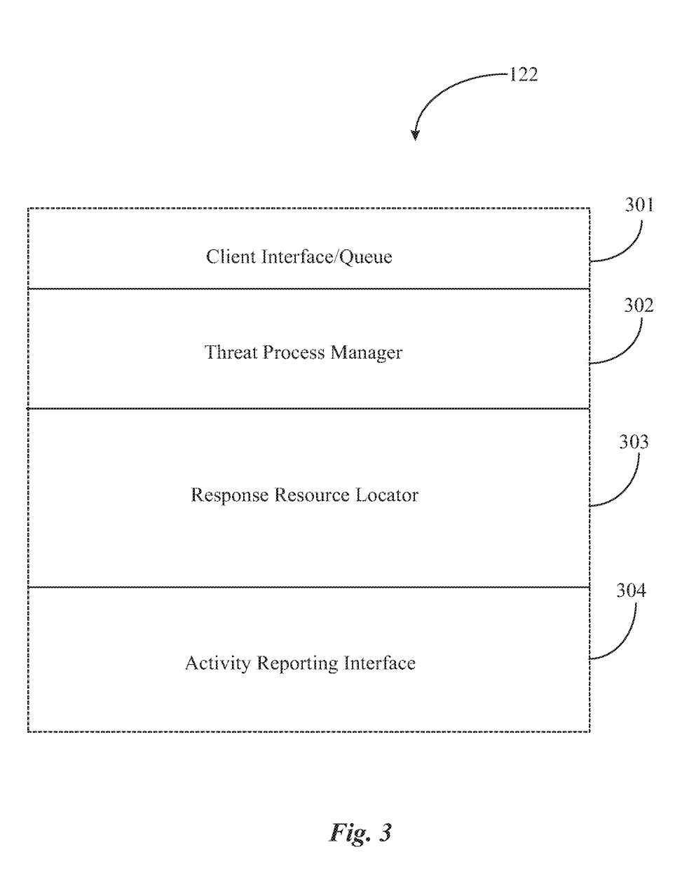

FIG. 3 is a block diagram depicting modules of a parent software application 122 used to process uploaded threat reports according to an embodiment of the present invention. Application 122 may include a client interface/queue 301. Interface 301 listens for threat uploads coming in over the network from business clients and queues them for processing. A threat queue may or may not be a first in first out (FIFO) queue. It is noted herein that a queue may not be required considering the total number of threat forms and the capability of automated processing of those forms.

Application 122 may include a threat process manager 302. Threat process manager 302 may be a continually running process or one that is executed when there is a threat form to process. Threat process manager 302 may determine, based on the threat category and amount of data included in the threat submission form, whether further data processing may be required to gain additional information to help quickly resolve the issue. The extent of what threat process manager does is largely dependent on the characteristics and parameters of the threat issued. For example, if the threat is local and the threat issuer is already known to the business, the threat manager may simply report the threat to the local authorities, perhaps confirming that it was already reported by the local administrator (follow-up).

Threat process manager 302 may retrieve data from the threat report form and use that data as search criteria to search for more granular data that may point to the identification of a threat issuer. The additional data found might be appended to the threat report form, which may be shared with law enforcement, FBI, or other regional or national agencies that may be local to the source of the original threat. In one implementation threat manger 302 may alert one or more human operators at the local businesses that uploaded the threat manually to direct them to complete a task during the process of threat resolution without departing from the spirit and scope of the present invention. One such task might be to manually report the incident to a specific agency or authority that may be local or not local.

Application 122 may include a response resource locator 303. Response resource locator 303 may be adapted to locate service, agencies, etc. that may be required to be notified according to parameters of the threat being processed. These data may consist of mainly contact data that may be utilized to report the threat or may be shared back to the local business for reporting the threat to the specified or recommended agencies. In one implementation a threat may be reported automatically by the system using synthesized voice or text. There may be prearrangements made with some agencies and authorities so that the reporting interface is recognized as a legitimate reporting source. In one implementation, agents of the client business associated with the threat being processed are responsible for reporting the incident. In this variation the service simply gathers the required reporting information and forwards that information through the portal to the administrator with instructions to report the incident including forward of the electronic form with the threat data. In another implementation only the network-based system reports incidents but copies the local business administrator on the report and activity for future follow-up during any investigation. There are many possibilities.

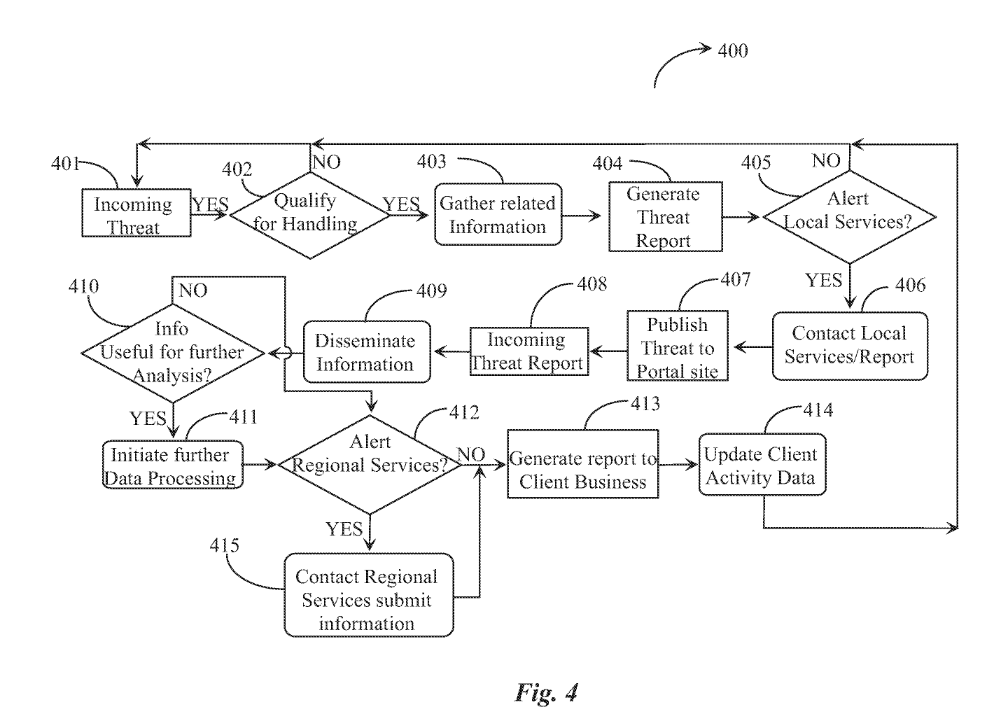

FIG. 4 is a process flow chart 400 depicting steps for two-party management of a threat received by one of the parties according to an embodiment of the present invention. At step 401 a threat is received at a client business. The threat may be received directly such as in a phone call to a worker or receptionist or it may be detected in some other form such as in a text message, an email message, in a hard mail package, or in a chat transcript.

At step 402, an administrator or other authority at the business may make a decision whether the threat received or detected at the local business qualifies for threat handling at all. If at step 402 the administrator or authority determines the threat is not credible and does not require handling, the process may resolve back to step 401. If at step 402, the administrator determines the threat should be handled the information gatherer may be executed to gather related information at step 403 that might exist on the local business operational platform (stored information).

In one example, the gathering of threat related information is automatic and executed in the background. An administrator may be required to enter the threat into the application. In another aspect the information gatherer may “look up” the threat event given it has arrived over a monitored channel. In this case the information gatherer may populate a threat form in the application with the data to register it in the threat handling system. In one implementation step 402 may occur in the process after step 403 in the case that additional data may be found and linked to data associated with the original threat.

At step 404, assuming the threat is determined credible, the application may generate a threat report for submission to the threat handling service. In this process the information gatherer may populate the threat form with appropriate data it has found locally. It is noted herein that if there is no data already in the business system that relates to an incoming threat the form will include only the data that was lifted from the communication event. In one embodiment an administrator or person receiving the threat may add information to the threat submission form that was not available to the information gatherer. Such information might be available if the threat comes into a worker that knows the threat originator whereas the system does not.

At step 405, the administrator operating the application may make a determination whether to alert local services. In one embodiment local reporting may be mandated for all threats received. In another embodiment the business may elect not to report a threat to local services. In one embodiment reporting may be automatic by the threat handling system with confirmation to the business for follow-up purposes. Investigators would be given the contact data for people to interview at the business along with all of the threat data and meta data gathered by the information gatherer.

If at step 405 the administrator determines not to report the threat to local authorities, the process may resolve back to step 401. If the administrator determines to report the threat to local authorities at step 405, the local authorities are contacted at step 406. This may occur before or after step 407. At step 407 the threat may be published (uploaded through portal) to the threat handling service. In the case of local reporting, the threat submission form may be forwarded to authorities for review at the time of the report.

At step 408 the threat handling server receives an incoming threat report. This may include the original threat data, gathered information, witness contact data, etc. All of this data may be included in the form fields of the threat submission form. At step 409, the threat handling server aided by SW 122 disseminates (parses) the information for completeness against the amount of data required to initiate an investigation. At step 410 the threat handling server may determine based on the evaluation at step 408 whether the information provided by the business in the threat submission form is useful for further analysis such as to gather additional information using existing information as search criteria.

If at step 410 the threat handling server determine the data requires no further analysis or amendments, the process may skip over to step 412 where the threat handling server may determine whether to alert regional services which may include state, national and international services. If at step 410 the threat handling server determines that the data could use more analysis, the server may initiate further data processing at step 411. To illustrate an example scenario, the system may receive a threat submission form where the data completely identifies the issuing party of the threat making further data expansion unnecessary. On the other hand, the data may be largely insufficient for making an identification of a threat issuing person or group, yet some of the data used in a search may produce additional data including a possible identification of the threat issuer.

At step 412 the threat handling server may determine whether or not to alert regional authorities or services. If at step 412 the server determines to alert regional services, the server may contact such services and submit the electronic form or file to them in progress of the alert or report. In one implementation this may be automatic and performed without human intervention. In another implementation the information is forwarded to an individual either associated the threat handling service or with the client business to make the report whereby the form data and correct contact information of the agency or agencies to report to is included in the submission form.

If at step 412, if the server determines not to alert regional services, the process may skip to step 414. At step 414, the threat handling server may generate a final report relative to the handling of the threat and send the report to the client business that received or detected the threat. At step 415, the client business receives the activity report and may update the repository holding client activity data updating the record for the threat submission. It is noted herein that additional updating may transpire between the local business client and threat handling server than is reflected in process 400.

It will be apparent to one with skill in the art that the threat handling system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will further be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A system, comprising:
a threat-resolution server connected to a wide-area network and having a processor executing first threat-processing software from a non-transitory medium; and
a computerized appliance connected to the WAN at a business enterprise executing second threat-processing software;
wherein the second threat-processing software enables a standardized summarization of an identified threat, gathering of available data useful for identifying a source of the threat, and transmission of a threat report to the threat-resolution server, where the first threat-processing software enables determination of a threat source from the data transmitted, suggests resolution steps back to the computerized appliance, and notified law-enforcement agencies, suicide prevention services, and other services as determined to be needed by nature of the threat.

2. The system of claim 1 wherein the computerized appliance is connected to a local-area network (LAN) hosted by the business enterprise, the LAN including communication channels used by the business enterprise, and the second threat-processing software enables analysis of interactions over the communication channels to determine and instantiate threat reports.

3. The system of claim 2 wherein interactions over voice channels are treated by voice-to-text conversion to produce text versions of voice interactions, and wherein text of interactions over all channels is compared to stored word and phrases to determine threat content.

4. The system of claim 3 wherein determination of threat content by the second software is displayed for analysis on a display screen of the computerized appliance to enable administrative personnel to make a manual analysis.

5. The system of claim 3 wherein the second software enables prioritizing of threat level, using stored definitions and rule sets.

6. The system of claim 1 wherein the first threat-processing software enables statistical analysis and reporting of threats.

7. The system of claim 6 wherein statistical analysis and reporting is by enterprise and by threat type.

8. A method, comprising:
identifying a threat by execution of threat-processing software executing on a computerized appliance at a business enterprise;
gathering available data useful in identifying a source for the threat;
preparing a threat report and transmitting the report to a threat-resolution server connected to a wide-area network, the server executing a first threat-processing software;
determining a source of the threat from the data transmitted from the computerized appliance;
transmitting suggestions for resolution back to the computerized appliance from the WAN-connected server; and
notifying law-enforcement agencies, suicide prevention services, and other services as determined to be needed by nature of the threat.

9. The method of claim 8 wherein the computerized appliance is connected to a local-area network (LAN) hosted by the business enterprise, the LAN including communication channels used by the business enterprise, and the second threat-processing software analyzes interactions over the communication channels to determine and instantiate threat reports.

10. The method of claim 9 wherein interactions over voice channels are treated by voice-to-text conversion to produce text versions of voice interactions, and wherein text of interactions over all channels is compared to stored word and phrases to determine threat content.

11. The method of claim 10 wherein determination of threat content by the second software is displayed for analysis on a display screen of the computerized appliance to enable administrative personnel to make a manual analysis.

12. The method of claim 10 wherein the second software enables prioritizing of threat level, using stored definitions and rule sets.

13. The method of claim 8 wherein the first threat-processing software enables statistical analysis and reporting of threats.

14. The method of claim 13 wherein statistical analysis and reporting is by enterprise and by threat type.
